(19) United States
(12) Patent Application Publication
(10) Pub. No.: US 2002/0064542 A1
(43) Pub. Date: May 30, 2002

(54) TISSUE PRODUCTS UTILIZING WATER SOLUBLE FILMS AS CARRIERS FOR ANTIVIRAL COMPOSITIONS AND PROCESS FOR MAKING

(76) Inventors: GEORGE ENDEL DECKNER, CINCINNATI, OH (US); KAMILAH APEWAIYE GBADAMOSI, FAIRFIELD, OH (US); STEPHEN ROBERT KELLY, OWENTON, KY (US); THOMAS JAMES KLOFTA, CINCINNATI, OH (US)

Correspondence Address: THE PROCTER & GAMBLE COMPANY, PATENT DIVISION, IVORYDALE TECHNICAL CENTER - BOX 474, 5299 SPRING GROVE AVENUE, CINCINNATI, OH, 45217, US

(21) Appl. No.: 09/342,777

(22) Filed: Jun. 29, 1999

(51) Int. Cl. A01N 25/34

(52) U.S. Cl. 424/404; 424/402

(57) ABSTRACT

A tissue product having an antiviral composition. The antiviral composition includes a film-forming water soluble carrier(s) and one or more antiviral agents. Optional ingredients such as surfactants, thickening agents, dyes, and scents may also be included. The tissue product may include an optional moisture barrier. The moisture barrier may be treated with the antiviral composition. A process for making the tissue product is also disclosed.

### TECHNICAL FIELD

This invention relates to tissue products comprising water soluble films utilized as carriers for antiviral compositions and a method for making.

### BACKGROUND OF THE INVENTION

Whether it be a household, workplace, educational facility or any other location where people tend to gather, preventing the spread of germs is a difficult but yet desirable task. For instance, it is well documented that many hours of productive work are lost due to individuals becoming infected with the common cold or influenza virus.

When one suffers from the common cold or influenza virus, one's mucus is the source of a very high concentration of viruses. After the mucus is deposited into a facial tissue, the virus within the mucus has the potential to infect other individuals coming into contact with it. Transfer of this mucus on the tissue to another individual will likely be through accidental or unintentional contact.

As an example of a possible transfer scenario, consider a cold sufferer who accidentally leaves a mucus infected facial tissue on a hard surface of some type. This hard surface might be a kitchen countertop, a bathroom vanity surface, an office desk or some other piece of furniture. Another family member or colleague may accidentally come into contact with the infected mucus after picking up the tissue to throw it away. After coming into such contact with the mucus on the tissue, it is very possible for that individual to become infected with the viral condition (i.e., common cold, influenza) especially if the infected mucus comes into contact with that individual's mucosal membranes.

Another transmission scenario is through the disposal of the facial tissues contaminated with the virus containing mucus. After a household waste basket becomes filled with trash containing a high concentration of infected tissues, it obviously needs to be disposed of in some manner. During this transfer of the household trash into another larger disposal unit, the individual transferring the trash may come into contact with the contaminated tissue. Once again, this individual is at a higher risk for contracting the virus.

Many other potential modes of virus transmission are possible after the facial tissue has become infected with the mucus. To reduce the probability of cold and influenza transmission, it is desirable to contain the virus to the tissue as well as kill this contained virus. Furthermore, it is desirable to delay the release of the antiviral agent contained in the tissue until liquid actually contacts the antiviral agent thereby reducing the potential for premature release of the antiviral agent as well as reducing the potential for skin irritation.

U.S. Pat. No. 4,738,847 issued to Rothe et al. on Apr. 19, 1988 purports to teach a three ply cellulosic tissue wherein a virucidal composition is substantially confined to the center ply.

U.S. Pat. No. 4,764, 418 issued to Kuenn et al. on Aug. 16, 1988 purports to teach a tissue comprising a cellulosic web, water-soluble humectant and carboxylic acid.

Both of these suffer from the same drawback. Neither is able to prevent the premature release and activation of the virucide.

Accordingly, it is desirable to provide a tissue product having an antiviral composition which utilizes a water soluble film as a vehicle for containing the antiviral agent. It is also desirable to provide a tissue product having an antiviral agent wherein the antiviral agent is not activated until contacted by liquid (e.g. water, mucus, etc.). Furthermore, it is desirable to provide a tissue product which confines the virus to the tissue.

The benefits of utilizing such a tissue include: (1) a tissue product that is mild to the skin; (2) a tissue product in which the antiviral agent remains in the tissue; (3) a tissue product in which the virus is confined to the tissue; and (4) a tissue product in which the antiviral agent is not released and activated until contacted by a liquid such as the virus-containing mucus. This allows maximization of the antiviral agent contact time with the virus as well as maximization of the antiviral agent available for contact with the virus. Hence, more efficient and effective virus kill is provided thereby inhibiting further virus transmission and contamination.

### SUMMARY OF THE INVENTION

The present invention relates to tissue products having antiviral compositions comprising water soluble films and a method for making the tissue products. The tissue products include an antiviral composition. The antiviral composition comprises a film-forming water soluble carrier(s) which comprises from about 1% to 90% of the antiviral composition by weight and an antiviral agent(s) which comprises from about 0.1% to 80% of the antiviral composition by weight.

Suitable film-forming water soluble carriers include but are not limited to poly-N-vinyl-pyrrolidone, copolymers of vinyl pyrrolidone and vinyl acetate, methylcellulose, ethylcellulose, water soluble hydroxyalkyl ethers of cellulose, hydroxyethylcellulose, ethylhydroxyethylcellulose, methylhydroxypropylcellulose, hydroxypropylguar, hydroxypropylstarch, chitosan, carboxymethylchitosan, arabinogalactan, hydroxypropylcellulose, or mixtures thereof.

Suitable antiviral agents include but are not limited to natural extracts, ascorbic acid, and carboxylic acids. Suitable carboxylic acids include but are not limited to carboxylic acids such as C₁ to C₁₂ saturated, unsaturated, or mixtures thereof of carboxylic acids possessing 1 to 4 carboxylic acid groups and having at least one hydroxyl group substituted on the C₂ alpha carbon; C₁ to C₁₂ saturated, unsaturated, aromatic, or mixtures thereof of carboxylic acids possessing 1 to 4 carboxylic acid groups and having at least one hydroxyl group substituted on the C₃ beta carbon; C₁ to C₁₂ saturated, unsaturated, aromatic, or mixtures thereof of carboxylic acids possessing 1 to 4 carboxylic acid groups; C₁ to C₁₂ saturated, unsaturated, aromatic, or mixtures thereof of carboxylic acids possessing 1 to 4 carboxylic acid groups and having a hydroxyl group(s) substituted on carbon number(s) C₄ or above; or mixtures thereof.

The antiviral composition may also include an optional nonionic surfactant wherein the nonionic surfactant comprises from about 0.1% to 90% of the antiviral composition by weight. A suitable nonionic surfactant includes but is not limited to an alkoxylated alcohol having an HLB of about 8 to 20 and the following formula:

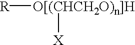

wherein: R=C₂−C₅₀ and may be either branched, unsaturated, or saturated

n=10-40

X=hydrogen, methyl, or ethyl.

The antiviral composition may also include an optional thickening agent wherein the thickening agent comprises from about 0.1% to 15% of the antiviral composition by weight.

The invention also includes a tissue product wherein the tissue product comprises one or more fibrous ply(ies). One or more fibrous plies may include an antiviral composition. For example, the tissue product may include a first fibrous ply whereby the first fibrous ply includes an antiviral composition comprised of a film-forming water soluble carrier(s) which comprises from about 1% to 90% of the antiviral composition by weight and an antiviral agent(s) which comprises from about 0.1% to 80% of the antiviral composition by weight.

The tissue product may include a second fibrous ply wherein the second fibrous ply is joined in a face to face relationship with the first fibrous ply. The second fibrous ply may optionally include an antiviral composition.

The tissue product may also include an optional moisture barrier. The optional moisture barrier may be impregnated into one or more fibrous plies and or joined in a face to face relationship with one or more of the fibrous plies. The optional moisture barrier may also optionally include an antiviral composition.

The invention further includes a process for making a tissue product. The process comprises the steps of providing a tissue web. An antiviral composition may be applied to the tissue web. An optional moisture barrier may also be included whereby the optional moisture barrier is impregnated into or disposed thereon the tissue web. The optional moisture barrier may optionally include an antiviral composition.

### BRIEF DESCRIPTION OF THE DRAWINGS

FIG. 1 is a vertical sectional view showing a first fibrous ply which includes the antiviral composition of the present invention.

FIG. 2 is a vertical sectional view showing a first and second fibrous plies, the first fibrous ply including the antiviral composition of the present invention.

FIG. 3 is a vertical sectional view showing three fibrous plies, all three fibrous plies including the antiviral composition of the present invention, the second fibrous ply interposed between the first and third fibrous plies.

FIG. 4 is a vertical sectional view showing a first fibrous ply, a second fibrous ply, and a moisture barrier interposed between the first and second fibrous plies, the moisture barrier including the antiviral composition of the present invention.

FIG. 5 is a vertical sectional view showing a first fibrous ply, a second fibrous ply, and a moisture barrier interposed between the first and second fibrous plies, the second fibrous ply including the antiviral composition of the present invention.

FIG. 6 is a schematic representation illustrating a process for applying the antiviral composition of the present invention to a tissue webs and/or a moisture barrier.

### DETAILED DESCRIPTION OF THE INVENTION

As used herein, the term “comprising” means that the various components, ingredients, or steps, can be conjointly employed in practicing the present invention. Accordingly, the term “comprising” encompasses the more restrictive terms “consisting essentially of” and “consisting of.”

As used herein, “antiviral agent” refers to something capable of killing viruses such as rhinovirus and influenza.

As used herein, “antiviral composition” refers to a composition which includes one or more antiviral agents.

As used herein, “film-forming” refers to a means of uniformly holding and delivering a functional material to a substrate.

As used herein, the terms “tissue paper web”, “paper web”, “web”, “paper sheet”, “tissue product”, and “paper product” all refer to sheets of paper made by a process comprising the steps of forming an aqueous papermaking furnish, depositing this furnish on a foraminous surface, such as a Fourdrinier wire, and removing the water from the furnish as by gravity or vacuum-assisted drainage, with or without pressing, and by evaporation.

As used herein the term “multi-ply tissue paper product” refers to a tissue paper comprised of at least two plies. Each individual ply in turn can be comprised of single-layered or multi-layered tissue paper webs. The multi-ply structures are formed by bonding together two or more tissue webs such as by gluing or embossing. Suitable methods for joining plies are disclosed in commonly assigned U.S. Pat. Nos.: 3,414,459 issued to Wells on Dec. 3, 1968; 3,867,225 issued to Nystrand on Feb. 18, 1975; 4,481,243 issued to Allen on Nov. 6, 1984; and 5,294,475 issued to McNeil on Mar. 15, 1994; the disclosures of which are all incorporated herein by reference.

As used herein, “carrier” and “vehicle” refer to a means for delivering the antiviral composition to the tissue.

As used herein, “moisture barrier” refers to a means for inhibiting the penetration of moisture through tissue. Suitable moisture barriers are disclosed in commonly assigned U.S. Ser. Nos. 08/813,421 filed Mar. 10, 1997 and 09/120,828 filed Jul. 22, 1998, the disclosures of which are incorporated herein by reference.

As used herein the terms “through air drying” and “blow through drying” refer to a technique of removing water from the web by drying the web with hot air.

As used herein, the terms “mechanical dewatering”, “conventional wet pressing”, and “conventional felt pressing” all refer to a technique of removing water from the web by mechanically pressing the web with a dewatering felt.

Though the principle use of this invention is in connection with facial tissues, it is also applicable to other tissue products including but not limited to: bath tissue, table napkins, toweling, and the like. The tissue paper may be conventionally wet pressed, through air dried tissue, high bulk pattern densified tissue paper, and high bulk, uncompacted tissue paper.

All percentages, ratios and proportions used herein are by weight unless otherwise specified.

Antiviral Composition

The antiviral composition is comprised of a film-forming water soluble carrier, antiviral agent(s), optional surfactant(s), and other optional ingredients such as but not limited to thickening agents, dyes, emollients, skin soothing agents, skin sensates, vitamins, and scents.

A. Film-forming Water Soluble Carrier

While not wishing to be bound by theory, it is believed that upon drying the film-forming water soluble carrier forms a thermoplastic film. The film formed by the film-forming water soluble carrier acts as a vehicle for delivering the other components of the antiviral composition (e.g. the antiviral agent, etc.) to the tissue substrate. Because the other components of the composition are contained (encompassed) within the film, the components are not activated (i.e.; are not released) until the film is contacted by a liquid medium (e.g., water, mucus, etc.). Hence, retention of the antiviral composition on the tissue is maximized. There is little opportunity that these other components will be released prematurely thus maximizing the efficacy of the antiviral composition upon the infected mucus.

Furthermore, it is believed that the potential for skin irritation is minimized as the antiviral agent is encompassed within the film and hence will not migrate out of the tissue. Yet further, as the antiviral agent remains within the film and is not activated nor released from the film until contacted by a liquid medium, the amount of antiviral agent available to kill the virus is maximized. Hence efficacy of the virucidal agent is enhanced.

The film-forming water soluble carriers of this invention have a molecular weight of about 2,000,000 or less, preferably about 500,000 or less and more preferably about 100,000 or less.

Suitable film-forming water soluble carriers include but are not limited to film-forming materials such as hydroxypropylguar, hydroxypropylstarch, water soluble polyurethanes, poly-N-vinyl-pyrrolidone, copolymers of vinyl pyrrolidone and vinyl acetate, methylcellulose, ethylcellulose, water soluble hydroxyalkyl ethers of cellulose, ethylhydroxyethylcellulose, methyl-hydroxypropylcellulose, chitosan, carboxymethylchitosan arabinogalactan, hydroxybutylcellulose, preferably hydroxyethylcellulose, and more preferably hydroxypropylcellulose. These film-forming water soluble carrier may either be used alone or in combination with one another.

Suitable hydroxypropylcelluloses include but are not limited to KLUCEL® LFF and KLUCEL® HF both commercially available from Hercules Incorporated of Wilmington, Del.

The film-forming water soluble carrier comprises from about 1% to 90% of the antiviral composition by weight, preferably from about 5% to 35%, of the antiviral composition by weight, and more preferably from about 10% to 25% of the antiviral composition by weight.

B. Antiviral Agent(s)

The antiviral agent(s) of the present invention are effective at killing certain strains of viruses such as influenza virus and rhinovirus. Furthermore, because the antiviral agent is encompassed within a water soluble film matrix which does not begin to release until contacted by moisture, the potential for skin irritation in areas contacted by the tissue is greatly reduced.

Antiviral agents suitable for use with this invention include but are not limited to natural extracts such as aconite, aloe, astragalus, Baikal skullcap, balm, black catechu, calendula, cangzhu, cedar leaf oil, Cherokee rosehip, cinnamon, cloves, cubebs, echinacea, epimedium, eucalyptus, forsythia fruit, garlic, giant knotweed, honeysuckle flower, hypericum, hyssop, magnolia flower, marjoram, mints, olive leaf extract, peony bark, peony root, pine needle oil, sage, Sichuan lovage, tannic acid, and tea.

Other suitable antiviral agents include but are not limited to organic acids such as ascorbic acid and carboxylic acids.

Suitable carboxylic acids include but are not limited to alpha hydroxy acids such as C₁ to C₁₂ saturated, unsaturated, or mixtures thereof of carboxylic acids possessing 1 to 4 carboxylic acid groups and having at least one hydroxyl group substituted on the C₂ alpha carbon with additional hydroxyl and other functionalities (i.e.; phenyl, amino, alkyl, etc.) optionally bound along the carbon chain and aromatic ring(s). A non-inclusive list of alpha hydroxy acids which may be used includes: 2-hydroxyhexanoic acid, 2-hydroxyoctanoic acid, 2-hydroxydecanoic acid, 2-hydroxydodecanoic acid, 2-hydroxycaprylic acid, citric acid, tartaric acid, mandelic acid, malic acid, glycolic acid, lactic acid, gluconic acid, hydroxycaprylic acid, 2-hydroxypropionic acid, 2-hydroxybutanoic acid, 2-hydroxypentanoic acid, and mixtures thereof.

Other examples of carboxylic acids useful with this invention include beta hydroxy acids such as C₁ to C₁₂ saturated, unsaturated, aromatic, or mixtures thereof of carboxylic acids possessing 1 to 4 carboxylic acid groups and having at least one hydroxyl group substituted on the C₃ beta carbon with additional hydroxyl and other functionalities (i.e.; phenyl, amino, hydroxyl, alkyl, etc.) optionally bound along the carbon chain or aromatic ring(s). A non-inclusive list of beta hydroxy acids useful with this invention includes: 3-hydroxyhexanoic acid, 3-hydroxyoctanoic acid, 3-hydroxydecanoic acid, 3-hydroxydodecanoic acid, 3-hydroxycaprylic acid, salicylic acid, 5-octanoyl salicylic acid, 3-hydroxybutanoic acid, 3-hydroxypentanoic acid, 3-hydroxypropionic acid, and mixtures thereof.

A non-inclusive list of other carboxylic acids useful with this invention includes C₁ to C₁₂ saturated, unsaturated, aromatic, or mixtures thereof of carboxylic acids possessing 1 to 4 carboxylic acid groups with optional functional groups (i.e.; phenyl, amino, hydroxyl, alkyl, etc.) substituted along the carbon chain or on the aromatic ring(s) such as propionic acid, hexanoic acid, octanoic acid, decanoic acid; C₁ to C₁₂ carboxylic acids possessing 1 to 4 carboxylic acid groups wherein a hydroxyl group(s) is substituted on carbon number(s) C₄ or above such as 4-hydroxyhexanoic acid, 5,6-dihydroxyhexanoic acid, 6-hydroxyhexanoic acid, 4-hydroxyoctanoic acid, 5-hydroxyoctanoic acid, 6-hydroxyoctanoic acid, 6,7,8-trihydroxyoctanoic acid, 8-hydroxyoctanoic acid, 4-hydroxydecanoic acid, 5-hydroxydecanoic acid, 6-hydroxydecanoic acid, 7-hydroxydecanoic acid, 8-hydroxydecanoic acid, 9-hydroxydecanoic acid, 10-hydroxydecanoic acid, 4-hydroxydodecanoic acid, 5-hydroxydodecanoic acid, 6-hydroxydodecanoic acid, 11-hydroxydodecanoic acid, and 12-hydroxydodecanoic acid; benzoic acid; phthalic acid; acetylsalicylic acid; dehydroacetic acid; sorbic acid; succinic acid; glutaric acid; adipic acid; sebacic acid; maleic acid; folic acid; acetic acid; ethylenediaminetetraacetic acid; glycolic acid; and mixtures thereof.

Preferred carboxylic acids useful with this invention include adipic acid, glutaric acid, succinic acid, lactic acid, acetylsalicylic acid, glycolic acid, tartaric acid, citric acid, salicylic acid, or mixtures thereof; more preferred is citric acid, salicylic acid or mixtures thereof; most preferred is salicylic acid. A suitable salicylic acid is available from Rhone- Poulenc SA of Cranbury, N.J.

The antiviral agent(s) comprises from about 0.1% to 80% of the antiviral composition by weight, preferably from about 5% to 70%, of the antiviral composition by weight, and more preferably from about 10% to 65% of the antiviral composition by weight.

C. Optional Surfactant

The antiviral composition may also include an optional nonionic surfactant.

While not wishing to be bound by theory, it is believed that the optional nonionic surfactant used in the antiviral composition serves several important functions.

The surfactant allows the paper to absorb water and mucus at a reasonable rate. Importantly in relation to antiviral activity, the surfactant can function to aid in solubilizing the lipid shell layer of the enveloped class of viruses. This solubilization of the lipid shell enhances the ability of the antiviral acids to penetrate into the virus structure and deactivate it. It should be noted that the antiviral agents of this invention may be made either with or without adding a surfactant.

Examples of suitable nonionic surfactants include but are not limited to alkoxylated alcohols having an HLB of about 8 to 20 and the following formula:

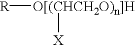

wherein R=C₂−C₅₀ and may be either branched, unsaturated, or saturated

n=10-40

X=hydrogen, methyl, or ethyl

A preferred alkoxylated alcohol is polyoxypropylene (5) polyoxyethylene (20) cetyl ether commercially available as PROCETYL AWS manufactured by Croda Incorporated of Parsippany, N..J.

The optional surfactant comprises from about 0.1% to 90% of the antiviral composition by weight, preferably from about 10% to 40%, of the antiviral composition by weight, and more preferably from about 15% to 30% of the antiviral composition by weight.

D. Other Optional Ingredients

Other optional ingredients which may be used include but are not limited to thickening agents, dyes, emollients, skin soothing agents, skin sensates, vitamins, and scents. Suitable thickening agents include but are not limited to natural and chemically modified gums such as KAPPA CARAGEENAN gum available from Sigma Aldrich Company of St. Louis, Mo. and hydroxypropylcellulose such as KLUCEL® HF commercially available from Hercules Incorporated of Wilmington, Del.

Other optional ingredients comprise from about 0.1% to 15% of the antiviral composition by weight, preferably from about 0.2% to 10%, of the antiviral composition by weight, and more preferably from about 0.3% to 5% of the antiviral composition by weight.

Tissue Substrate

Though the principle use of this invention is in connection with facial tissues, it is also applicable to other tissue products including but not limited to: bath tissue, table napkins, toweling, and the like. The tissue substrate of the present invention may be conventionally wet pressed or through air dried. The tissue substrate can be of a homogenous or multi-layered construction; and tissue paper products made therefrom can be of a single-ply or multi-ply construction.

The tissue substrate of the present invention may be cellulosic, noncellulosic, or a combination thereof. Suitable tissue substrates may be made according to commonly assigned U.S. Pat. Nos.: 3,301,746, issued to Sanford et al. on Jan. 31, 1967; 3,473,576 issued to Amneus on Oct. 21, 1969; 3,573,164 issued to Friedberg et al., on Mar. 30, 1971; 5,812,000 issued to Salvucci et al. on May 21, 1974; 3,821,068 issued to Salvucci et al. on May 21, 1974; 3,974,025, issued to Ayers on Aug. 10, 1976; 3,994,771, issued to Morgan, Jr. et al. on Nov. 30, 1976; 4,191,609 issued to Trokhan on Mar. 4, 1980; 4,208,459 issued to Becker et al. on Jun. 17, 1980; 4,225,382, issued to Kearney et al. on Sep. 30, 1980; 4,239,065 issued to Trokhan on Dec. 16, 1980; 4,300,981 issued to Carstens on Nov. 17, 1981; 4,440,597 issued to Wells et al. on Apr. 3, 1984; 4,528,239 issued to Trokhan on Jul. 9, 1985; 4,637,859 issued to Trokhan on Jan. 20, 1987; 4,919,756 issued to Sawdai on Apr. 24, 1992; 4,981,557 issued to Bjorkquist on Jan. 1, 1991; 5,098,522 issued to Smurkowski on Mar. 24, 1992; 5,217,576 issued to Van Phan on Jun. 8, 1993; 5,223,096 issued to Phan et al. on Jun. 29, 1993; 5,240,562 issued to Phan et al. on Aug. 31, 1993; 5,245,025 issued to Trokhan et al. on Jun. 11, 1994; 5,275,700 issued to Trokhan on Jan. 4, 1994; 5,277,761 issued to Phan et al. on Jan. 11, 1994; 5,279,767 issued to Phan et al. on Jan. 18, 1994; 5,328,565 issued to Rasch et al., on Jul. 12, 1994; 5,332,118 issued to Muckenfuhs on Jul. 26, 1994; 5,334,289 issued to Trokhan et al. on Aug. 2, 1994; 5,364,504, issued to Smurkoski et al. on Nov. 15, 1994; 5,366,785, issued to Sawdai on Nov. 22, 1994; 5,415,737 issued to Phan et al. on May 16, 1995; 5,443,691 issue to Phan et al. on Aug. 22, 1995; 5,496,624 issued to Stelljes, Jr. et al., on Mar. 5, 1996; 5,500,277 issued to Trokhan et al., on Mar. 19, 1996; 5,503,715 issued to Trokhan et al. on Apr. 2, 1996; 5,510,000 issued to Phan et al. on Apr. 23, 1996; 5,527,428 issued to Trokhan et al. on Jun. 18, 1996; 5,529,664 issued to Trokhan et al. on Jun. 25, 1996; 5,534,326 issued to Trokhan et al. on Jul. 9, 1996; 5,538,595 issued to Trokhan et al., on Jul. 23, 1996; 5,543,067 issued to Phan et al. on Aug. 6, 1996; 5,614,061 issued to Phan et al. on Mar. 25, 1997; 5,628,876 issued to Ayers et al., on May 13, 1997; 5,654,076 issued to Trokhan et al. on Aug. 5, 1997; 5,679,222 issued to Rasch et al., on Oct. 21, 1997; 5,690,790 issued to Headlam et al. on Nov. 25, 1997; 5,760,212 issued to Smith on Jun. 2, 1998; 5,804,036 issued to Phan et al. on Sep. 8, 1998; 5,804,281 issued to Phan et al. on Sep. 8, 1998; 5,820,730 issued to Phan et al. on Sep. 8, 1998; 5,830,317 issued to Vinson et al. on Nov. 3, 1998; 5,846,380 issued to Van Phan et al. on Dec. 8, 1998; or commonly assigned U.S. Ser. Nos. 08/813,421 filed Mar. 10, 1997 and 09/120,828 filed Jul. 22, 1998; the disclosures of which are all incorporated herein by reference.

A tissue substrate suitable for the present invention typically will have a basis weight of about 5 pounds to 80 pounds per 3000 square feet, preferably about 6 pounds to 70 pounds per 3000 square feet, more preferably about 7 pounds to 60 pounds per 3000 square feet, and most preferably 8 pounds to 50 pounds per 3000 square feet.

The tissue substrate of the present invention comprises at least one fibrous ply and preferably two or more fibrous plies. The fibrous ply may be noncellulosic, preferably cellulosic, or a combination thereof. The fibrous ply may be layered. An antiviral composition made according to the present invention may be applied to one or more of the fibrous plies. Each fibrous ply has two sides. Side one of the fibrous ply is oriented outwardly toward the user (i.e.; outward side) while side two of the fibrous ply is oriented away from the user (i.e.; the opposite-side). The antiviral composition may be applied to either or both side one or side two of the fibrous ply.

Optional Moisture Barrier

The tissue product may optionally include one or more moisture barriers. An antiviral composition may optionally be applied to the moisture barrier. The optional moisture barrier may be joined, connected to, placed on, or impregnated into the fibrous ply.

Moisture barriers and a method for making moisture barriers suitable for use with the present invention are disclosed in commonly assigned U.S. Ser. Nos. 08/813,421 filed Mar. 10, 1997 and 09/120,828 filed Jul. 22, 1998 the disclosures of which are incorporated herein by reference.

Suitable methods for joining fibrous plies with one another and/or with one or more moisture barriers include but are not limited to ply bonding such as disclosed in commonly assigned U.S. Pat. Nos.: 3,414,459 issued to Wells on Dec. 3, 1968; 3,867,225 issued to Nystrand on Feb. 18, 1975; 4,481,243 issued to Allen on Nov. 6, 1984; and 5,294,475 issued to McNeil on Mar. 15, 1994; the disclosure of which are incorporated herein by reference.

Embodiments

The embodiments described below are not intended to be limiting but merely exemplary in nature. It would be obvious to those skilled in the art that various other changes and modifications can be made without departing from the spirit and scope of the invention.

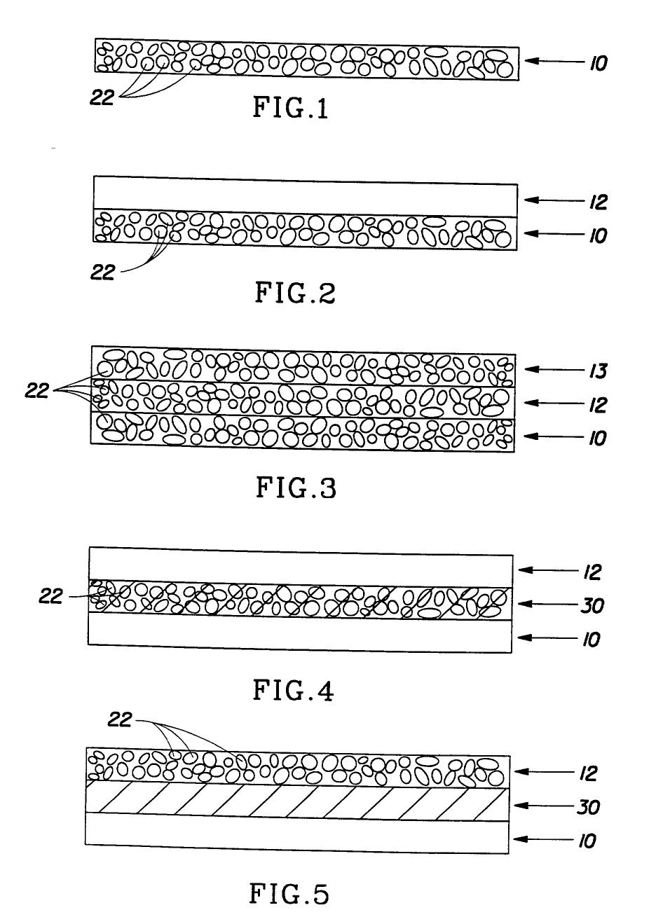

In one embodiment of the present invention shown in FIG. 1, first fibrous ply 10 includes antiviral composition 22.

In a second embodiment of the present invention shown in FIG. 2, first fibrous ply 10 includes antiviral composition 22. Second fibrous ply 12 is joined in a face to face relationship with first fibrous ply 10.

In a third embodiment of the present invention shown in FIG. 3, first fibrous ply 10 is joined in face to face relationship with second fibrous ply 12 and third fibrous ply 13. Each of the three fibrous plies includes antiviral composition 22.

In a fourth embodiment of the present invention shown in FIG. 4, first fibrous ply 10 is joined in a face to face relationship with moisture barrier 30 which includes antiviral composition 22 and second fibrous ply 12. Moisture barrier 30 is interposed between first fibrous ply 10 and second fibrous ply 12.

In a fifth embodiment of the present invention shown in FIG. 5, first fibrous ply 10 is joined in a face to face relationship with moisture barrier 30 and second fibrous ply 12. Second fibrous ply 12 includes antiviral composition 22. Moisture barrier 30 is interposed between first fibrous ply 10 and second fibrous ply 12.

In a sixth embodiment of the present invention (not shown), a first fibrous ply is joined in face to face relationship with a second fibrous ply and a third fibrous ply. The first fibrous ply and the third fibrous ply each include the antiviral composition of this invention.

This invention is not limited to only one fibrous ply or two fibrous ply embodiments, but can also include embodiments that are not shown utilizing more than two fibrous plies. These embodiments may also optionally include one or more moisture barrier(s). The moisture barrier(s) may either include or not include the antiviral composition. The invention can also include one or more fibrous plies wherein a moisture barrier is impregnated into one or more of the fibrous plies such as taught in U.S. Ser. No. 08/813,421 filed Mar. 10, 1997 the disclosure of which is incorporated by reference. The moisture barrier impregnated into the fibrous ply can either include or not include the antiviral composition. Furthermore, the fibrous ply into which the moisture barrier is impregnated, can either include or not include the antiviral composition.

The tissues of this invention may also contain combinations of the various embodiments disclosed herein. Furthermore, while particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### EXAMPLES

### Example of Method of Preparation of Antiviral Composition

Approximately 2168 grams of water were added to a mixing tank. The water was heated to 1500° F. and agitated with a LIGHTNIN mixer, Model No. TF2910 commercially available from General Signal of Tulsa, Okla. Approximately 360 grams of powdered hydroxypropylcellulose, (i.e.; a film-forming water soluble carrier commercially sold as KLUCEL®LFF by Hercules Incorporated of Wilmington, Del. was added to the water and agitated until a smooth solution (i.e.; no lumps) was formed. The solution was cooled to room temperature.

Approximately 360 grams of a nonionic surfactant (i.e.; polyoxypropylene (5) polyoxyethylene (20) cetyl ether sold as PROCETYL AWS by Croda Incorporated of Parsippany, N.J.) was added to the cooled solution. The solution was then agitated.

While continuing agitation, approximately 1080 grams of an antiviral agent (i.e.; salicylic acid commercially available from Rhone-Poulenc SA of Cranbury, N.J.) was added to the solution.

The suspension was transferred to a Hobart mixer (i.e.; Model No. A120 manufactured by Hobart Corporation of Troy, Ohio). Approximately 32 grams of a thickening agent (i.e.; CARAGEENAN gum commercially available from Sigma Aldrich Company of St. Louis, Mo.) was added to the solution.

### Example of Method of Application of Antiviral Composition to the Tissue Substrate and/or Optional Moisture Barrier

Even though described below in terms of application to a tissue web, all of these application methods may also be used interchangeably to apply the antiviral composition to the moisture barrier of this invention.

In preparing tissue paper products containing antiviral compositions according to the present invention, the antiviral composition may be applied to at least one surface of a tissue paper web. Suitable methods include spraying, hot melt spraying, printing (e.g., flexographic printing), coating (e.g., gravure coating), extrusion, or combinations of these application techniques, e.g. spraying the antiviral composition on a rotating surface, such as a calender roll, that then transfers the composition to the surface of the paper web. The antiviral composition can be applied either to one surface of the tissue paper web, or both surfaces.

The antiviral composition can be applied to the tissue paper web either before or after the web has been dried, i.e. a “dry web” addition method. The antiviral composition is applied in an amount of from about 1% to 100% by weight of the tissue paper web, preferably from about 5% to 60% by weight of the tissue paper web, most preferably from about 10% to 25% by weight of the tissue paper web.

The antiviral composition can also be applied non-uniformly to the surface(s) of the tissue paper web. By “non-uniform” is meant that the amount, pattern of distribution, etc. of the antiviral composition can vary over the surface of the paper. For example, some portions of the surface of the tissue paper web can have greater or lesser amounts of antiviral composition, including portions of the surface that do not have any antiviral composition on it.

An example of non-uniform application is where the tissue structure contains differing amounts and differing compositions of various formulations throughout its structure or alternatively where some zones may contain no antiviral composition at all.

The antiviral composition can also be applied to the tissue paper web at any point after it has been dried. For example, the antiviral composition can be applied to the tissue paper web after it has been creped from a Yankee dryer, but prior to calendering, i.e., before being passed through calender rolls. The antiviral composition can also be applied to the paper web after it has passed through such calender rolls and prior to being wound up on a parent roll. Usually, it is preferred to apply the antiviral composition to the tissue paper as it is being unwound from a parent roll and prior to being wound up on smaller, finished paper product rolls.

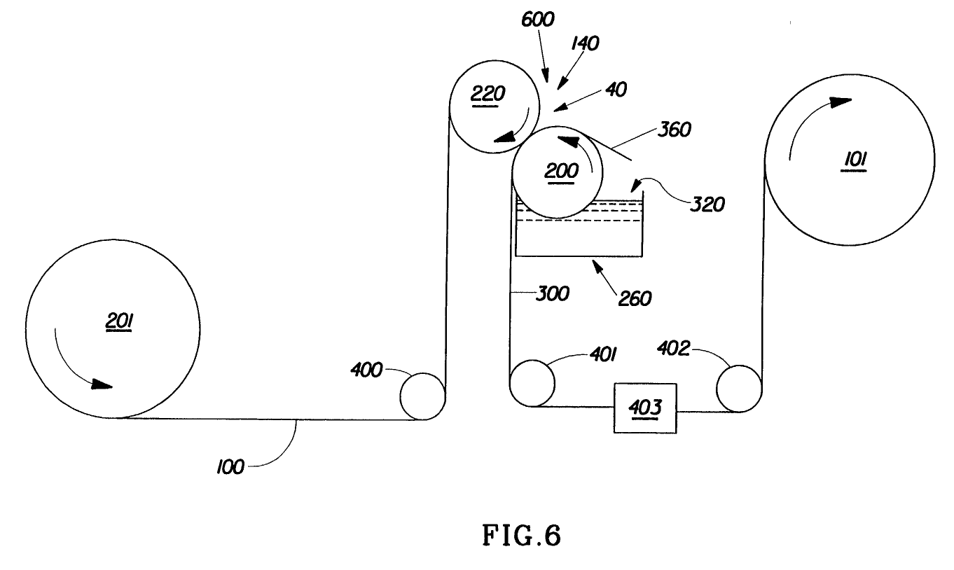

FIG. 6, illustrates a suitable application method involving gravure coating. Referring to FIG. 6, a dried tissue web 100 is unwound from parent tissue roll 201 and advanced around turning roll 400. From turning roll 400, web 100 is advanced to a direct gravure coating station 600 where the antiviral composition is applied to one side of the web. After leaving coating station 600, web 100 becomes treated web 300. The treated web 300 is then advanced around turning roll 401 and sent through drying oven 403. It then proceeds around turning roll 402 and is wound up on antiviral treated tissue product roll 101.

Gravure coating station 600 comprises press 140 which includes drive roll 220 and gravure cylinder 200. As shown in FIG. 6, drive roll 220 and gravure cylinder 200 provide nip area 40 through which tissue web 100 passes.

Positioned beneath gravure cylinder 200 is fountain tray 260. Antiviral composition is pumped into fountain tray 260 to provide antiviral composition reservoir 320. As gravure cylinder 200 rotates within reservoir 320, it picks up a quantity of antiviral composition. Excess antiviral composition on gravure cylinder 200 is then removed by doctor blades 360.

Methods of controlling the amount of antiviral composition transferred to web 100 include but are not limited to: (1) adjusting the width of nip area 400 between drive roll 220, and gravure cylinder 200, (2) adjusting the line speed, (3) changing the cell volume of gravure cylinder 200, or (4) changing the solution properties of the antiviral composition (e.g.; surface tension, viscosity, etc.).

While particular embodiments of the present invention are illustrated and described herein, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An antiviral composition, said antiviral composition comprising:
a) a film-forming water soluble carrier(s) wherein said film-forming water soluble carrier comprises from about 1% to 90% of said antiviral composition by weight and
b) an antiviral agent(s) wherein said antiviral agent comprises from about 0.1% to 80% of said antiviral composition by weight.

2. The antiviral composition according to claim 1 wherein said film-forming water soluble carrier is poly-N-vinyl-pyrrolidone, copolymers of vinyl pyrrolidone and vinyl acetate, methylcellulose, ethylcellulose, water soluble hydroxyalkyl ethers of cellulose, hydroxyethylcellulose, ethylhydroxyethylcellulose, methylhydroxypropylcellulose, hydroxypropylguar, hydroxypropylstarch, chitosan, carboxymethylchitosan, arabinogalactan, hydroxypropylcellulose, or mixtures thereof.

3. The antiviral composition according to claim 2 wherein said film-forming water soluble carrier is hydroxypropylcellulose.

4. The antiviral composition according to claim 1 wherein said antiviral agent is C₁ to C₁₂ saturated, unsaturated, or mixtures thereof of carboxylic acids possessing 1 to 4 carboxylic acid groups and having at least one hydroxyl group substituted on the C₂ alpha carbon; C₁ to C₁₂ saturated, unsaturated, aromatic, or mixtures thereof of carboxylic acids possessing 1 to 4 carboxylic acid groups and having at least one hydroxyl group substituted on the C₃ beta carbon; C₁ to C₁₂ saturated, unsaturated, aromatic, or mixtures thereof of carboxylic acids possessing 1 to 4 carboxylic acid groups; C₁ to C₁₂ saturated, unsaturated, aromatic, or mixtures thereof of carboxylic acids possessing 1 to 4 carboxylic acid groups and having a hydroxyl group(s) substituted on carbon number(s) C₄ or above; or mixtures thereof.

5. The antiviral composition according to claim 4 wherein said antiviral agent is adipic acid, glutaric acid, succinic acid, lactic acid, acetylsalicylic acid, glycolic acid, salicylic acid, 5-octanoyl salicylic acid, citric acid, tartaric acid, or mixtures thereof.

6. The antiviral composition according to claim 5 wherein said antiviral agent is salicylic acid.

7. The antiviral composition according to claim 1 wherein said antiviral composition further comprises a nonionic surfactant(s) whereby said nonionic surfactant comprises from about 0.1% to 90% of the antiviral composition by weight.

8. The antiviral composition according to claim 7 wherein said nonionic surfactant is an alkoxylated alcohol having an HLB of about 8 to 20 and the following formula: 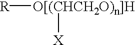
wherein: R=C₂- C₅₀ and may be either branched, unsaturated, or saturated
n=10-40
X=hydrogen, methyl, or ethyl.

9. The antiviral composition according to claim 8 wherein said alkoxylated alcohol is polyoxypropylene (5) polyoxyethylene (20) cetyl ether.

10. The antiviral composition according to claim 1 wherein said antiviral composition further comprises an optional thickening agent, whereby said thickening agent comprises from about 0.1% to 15% of the antiviral composition by weight.

11. A tissue product, said tissue product comprising:
(a) a first fibrous ply wherein said first fibrous ply includes an antiviral composition, said antiviral composition comprising:
b) a film-forming water soluble carrier(s) wherein said film-forming water soluble carrier comprises from about 1% to 90% of said antiviral composition by weight and
c) an antiviral agent(s) wherein said antiviral agent comprises from about 0.1% to 80% of said antiviral composition by weight.

12. A tissue product according to claim 11 further comprising a moisture barrier, said moisture barrier joined in a face to face relationship with said first fibrous ply.

13. A tissue product according to claim 12 wherein said moisture barrier further comprises an antiviral composition, said antiviral composition comprising:
a) a film-forming water soluble carrier(s) wherein said film-forming water soluble carrier comprises from about 1% to 90% of said antiviral composition by weight and
b) an antiviral agent(s) wherein said antiviral agent comprises from about 0.1% to 80% of said antiviral composition by weight.

14. A tissue product according to claim 12 further comprising a second fibrous ply, said second fibrous ply joined in a face to face relationship with said first fibrous ply and said moisture barrier, said moisture barrier disposed between said first fibrous ply and said second fibrous ply.

15. A tissue product according to claim 13 further comprising a second fibrous ply, said second fibrous ply joined in a face to face relationship with said first fibrous ply and said moisture barrier, said moisture barrier disposed between said first fibrous ply and said second fibrous ply.

16. A tissue product according to claim 12 further comprising a second fibrous ply, said second fibrous ply joined in a face to face relationship with said first fibrous ply and said moisture barrier, said moisture barrier disposed between said first fibrous ply and said second fibrous ply, wherein said second fibrous ply includes an antiviral composition, said antiviral composition comprising:
a) a film-forming water soluble carrier(s) wherein said film-forming water soluble carrier comprises from about 1% to 90% of said antiviral composition by weight and
b) an antiviral agent(s) wherein said antiviral agent comprises from about 0.1% to 80% of said antiviral composition by weight.

17. A tissue product, said tissue product comprising:
a first fibrous ply, a second fibrous ply, and a moisture barrier, said second fibrous ply joined in a face to face relationship with said first fibrous ply and said moisture barrier, said moisture barrier disposed between said first fibrous ply and said second fibrous ply, said moisture barrier including an antiviral composition wherein said antiviral composition comprises:
a) a film-forming water soluble carrier(s) wherein said film-forming water soluble carrier comprises from about 1% to 90% of said antiviral composition by weight and
b) an antiviral agent(s) wherein said antiviral agent comprises from about 0.1% to 80% of said antiviral composition by weight.

18. A tissue product according to claim 11, wherein said first fibrous ply further comprises a moisture barrier, said moisture barrier impregnated into said first fibrous ply.

19. A tissue product according to claim 11, said tissue product further comprising a second fibrous ply said second fibrous ply joined in a face to face relationship with said first fibrous ply.

20. A process for making a tissue product, said process comprising the steps of:
(a) providing a tissue web;
(b) applying an antiviral composition to said tissue web, said antiviral composition comprising:
i) a film-forming water soluble carrier(s) wherein said film-forming water soluble carrier comprises from about 1% to 90% of said antiviral composition by weight and
ii) an antiviral agent(s) wherein said antiviral agent comprises from about 0.1% to 80% of said antiviral composition by weight.

21. A process for making a tissue product according to claim 20, said process further comprising the step of:
(a) providing a moisture barrier wherein said moisture barrier is impregnated into said tissue web or joined to said tissue web in a face to face relationship.
